(19) United States
(12) Patent Application Publication
(10) Pub. No.: US 2014/0138357 A1
(43) Pub. Date: May 22, 2014

(54) POWER DISTRIBUTION SWITCHGEAR CIRCUIT BREAKER

(71) Applicants: Krysztof Kasza, Krakow (PL); Lukasz Malinowski, Krakow (PL); Gianluca Cortinovis, Albino (Bg) (IT)

(72) Inventors: Krysztof Kasza, Krakow (PL); Lukasz Malinowski, Krakow (PL); Gianluca Cortinovis, Albino (Bg) (IT)

(21) Appl. No.: 14/234,162

(22) PCT Filed: Jun. 13, 2012
(86) PCT No.: PCT/EP2012/002528

§ 371 Date: Jan. 22, 2014

(30) Foreign Application Priority Data
Jul. 25, 2011 (EP) 11460038.0

(51) Int. Cl. H01H 33/04; H01H 11/00

(52) U.S. Cl. CPC H01H 33/04; H01H 11/00
USPC 218/134; 29/622

(57) ABSTRACT

The invention relates to a power distribution switchgear circuit breaker applicable especially to medium or high voltage distribution board switchgears. The power distribution switchgear circuit breaker comprises at least one breaking element in the form of vacuum chamber or SF6 pole, which is provided with electric terminals, to which there are non-permanently connected the ends of contact arms, made in the form of a metal tube. The circuit breaker according to the invention is characterized in that the metal tube of the contact arms has all cross-sections perpendicular to the axis of the tube without any discontinuities along the whole length of the tube and it is located in an insulating casing which is provided with cooling elements which are located on the outer surface of the casing and which form an integral part with the casing.

The invention relates to a power distribution switchgear circuit breaker applicable especially to medium or high voltage distribution switchgears.

The main elements of medium voltage circuit breakers are breaking elements in the form of vacuum chambers or SF6 poles, actuators, elements of the kinematic chain, and connecting elements called contact arms. The basic function of the contact arms is to ensure electric contact between the terminals of the circuit breaker on the one hand, and the bus bars and cables of the distribution switchgear, on the other. Both the contact arms and the whole equipment of the distribution switchgear have to be functional without excessive overheating in conditions defined by the relevant standards, and to ensure electric insulation between the phases and the grounded elements of the distribution switchgear.

Large amounts of heat are generated in medium and high voltage equipment due to high values of currents flowing in it, which may lead to equipment failures caused by overheating. Considering that, the admissible maximum temperatures for such equipment are regulated by relevant standards. The main sources of heat in this type of apparatus are spots with the highest electric resistance, such as breaking elements mounted in medium voltage circuit breakers, e.g. vacuum chambers or SF6 poles. A significant source of heat inside a breaking element such as a vacuum chamber are contacts which due to the lack of convection in vacuum and small dimension of it in respect to others components of switchgear current path, are cooled only by the thermal conductivity of the elements of the current path and partly by radiation to the walls of the vacuum chamber. Very often vacuum chambers are encapsulated in resin or a thermoplastic material, which additionally reduces the ability to carry away heat by radiation. Vacuum chambers or SF6 poles are the basic components of medium voltage circuit breakers, hence their fast and reliable cooling is required.

Standard contact arms, having the shape of a thick-walled tube, plate, rod or others, are made of low-resistance materials, e.g. copper or aluminum. Additionally, they have to be covered with a layer of material providing electric insulation to prevent breakdowns between phases, and between phases and grounded elements.

Circuit breakers and cables in the cable connection compartment and the bus-bar compartment are electrically connected with the distribution switchgear circuit breaker by means of contact arms. The connection of contact arms and cables is located in casings called “spouts”, made of an electrically insulating material. The connection between the contact arm and the cable of each of the three phases is located in a separate “spout” which can be located on a separate bracket or on a bracket common for the three phases. Because of the required electric insulation between individual phases, the contact arms are located, on a large part of their length, inside the already mentioned casings, so that only about one third of the length of the arm is outside the casing. Such design causes that the outside dimensions of the contact arms are limited.

Large currents flowing through contact arms generate heat which can additionally flow to the arms through heat conductivity from the vacuum chamber or the SF6 pole of the distribution switchgear circuit breaker, as well as from other elements of the distribution switchgear, such as bus bars or connection cables. Effective heat conduction from contact arms significantly affects the maximum temperatures inside the power distribution switchgear circuit breaker. Contact arms for example are made in the form of metal thick-walled tubes containing longitudinal through holes. The whole surface of the tube is covered with a layer of insulating material.

The central through hole of the thick-walled tube is used to introduce a suitable key through this hole. By means of this key a contact arm is attached to the electric terminals located in the vacuum chamber or in the SF6 poles of the circuit breaker. The longitudinal holes increase the heat exchanging surface that conducts heat to the surrounding cooling medium, e.g. air, but at the same time they limit the surface of the cross-section of the arms and cause an increase in resistance to the flow of current, thus contributing to an increase in the amount of generated heat. Limitations in the dimensions of the casings cause that it is not possible to significantly increase the diameter of the contact arms, which would limit their heat losses, would increase the surface for carrying heat away, and would allow to increase the admissible current values. Therefore there is a need to use an improved design of contact arms, which would maintain the geometric limitations, would have an increased ability to carry heat away and thereby would allow also to increase the values of admissible currents flowing through the contact arms. There is no known solution allowing at the same time to meet these conditions for contact arms located in the insulating casing, i.e. in the spout.

From European patent EP1403891 there is known the circuit breaker which has an arcing chamber filled with an isolating gas, extends along a longitudinal axis. The breaker is equipped with a deflection device which interacts with an opening in a hollow contact arm. The hollow contact has a form of a metal tube having on its ends radial openings for hot gases. The end of the hollow contact arm is closed on its end by the deflection device which is connected with the electric terminal of the breaker. The deflection device is arranged on a side of the contact facing away from an arc area, for radial deflection of hot gases into an exhaust volume outside the contact arm.

There are known metal radiators mounted on current conduits to achieve quick and reliable cooling. However, the placement of metal radiators inside a distribution switchgear sometimes results in electric field disturbance inside the distribution switchgear and may lead to breakdowns between individual conductive elements.

There are also known radiators made of thermoplastic materials, which are mounted on bus bars in distribution switchgears. And so, European application EP2280460 describes an insulating radiator intended for distribution switchgears, which is an injection molding comprising a base plate to whose upper face an arrangement of heat-conducting elements of the same or varied shape is attached, and flexible mounting fasteners are attached to its side surfaces. The radiator is made of an insulating thermoplastic material with increased thermal conductivity of λ≧2 W/mK. The radiator is located in the electric field of the distribution switchgear and it is non-permanently connected with at least one bus bar or/and at least one conductive bus. However, radiators of the design described under application EP2280460 are not suitable for direct application on contact arms because they are not designed to ensure full electrical insulation of the element to which they are mounted.

The essence of the power distribution switchgear circuit breaker according to the invention, comprising at least one breaking elements in the form of vacuum chamber or SF6 pole, which is provided with electric terminals, to which there are non-permanently connected the ends of contact arms made in the form of a metal tube, is that the metal tube of the contact arms has its all cross-sections perpendicular to the axis of the tube (12) without discontinuities along the whole length of the tube and that it is placed in an insulating casing. The insulating casing is furnished with cooling elements which are located on its outer surface and which form an integral part with the casing. The casing (13) is made of a thermoplastic material of thermal conductivity of λ>2 W/mK and with dielectric properties.

Preferably, the length of the insulating casing is less than the length of the metal tube.

Preferably, the cooling elements have the form of transverse, longitudinal, spiral ribs, single splines and/or their combination.

Preferably, breaking elements are encapsulated in electrical insulation material.

The essence of a method of production a contact arm (10) for the circuit breaker according to claim 1-4 is that the contact arm is formed in one production cycle by overmolding a metal tube with an electrically insulating thermoplastic material characterized by high thermal conductivity of λ>2 W/mK, which after hardening forms an insulating casing together with cooling elements.

Alternatively, the contact arm is formed in at least two production cycles in which, first, a metal tube is overmolded with a thermoplastic material characterized by high thermal conductivity of λ>2 W/mK and dielectric properties, which after hardening forms a smooth outer layer on the metal tube, and then, on the surface of this layer, cooling elements are formed in the successive production cycles by further overmolding the tube.

The essence of the electric power distribution switchgear according to the invention, comprising a bus bar compartment, a circuit breaker compartment, a cable compartment and a low voltage compartment is that the circuit breaker according to claims 1 through 4 is located in the circuit breaker compartment.

The advantage of the power distribution switchgear circuit breaker according to the invention is that it makes it possible to increase admissible working currents and/or optimize the elements of the current path in the distribution board switchgear, while maintaining the requirements concerning the permissible maximum working temperatures inside the circuit breaker. This is possible due to the increased ability to carry heat away from the contact arms while the arms keep the necessary electric insulation. Optimization and the resulting decrease in the dimensions of the current path elements, which are made of copper or aluminum, facilitates savings in materials and potential miniaturization of the circuit breaker and of the whole distribution board switchgear. Also the increase in admissible working currents permits improvement in the operating parameters of the distribution board switchgear without the need to increase its dimensions.

The use of a thermoplastic material of increased thermal conductivity and with maintained electro-insulating properties ensures good heat exchange and protects against phase-to-phase faults and phase-to-ground faults. In addition, thermoplastic materials have low specific gravity and components made of them have small mass, so they do not require changes in the design of the distribution board switchgear. In contrast to the currently applied solution in which contact arms have the shape of a tube with additionally cut openings along the length of the arms, in the presented invention the shape of contact arms has been simplified to a tube with an invariable shape of the cross-section along the whole length of the arm. The proposed design is simpler in manufacturing and does not involve losses in materials resulting from cutting the holes, which also ensures a constant sectional area for current flow.

The invention is presented in an embodiment in the drawing where

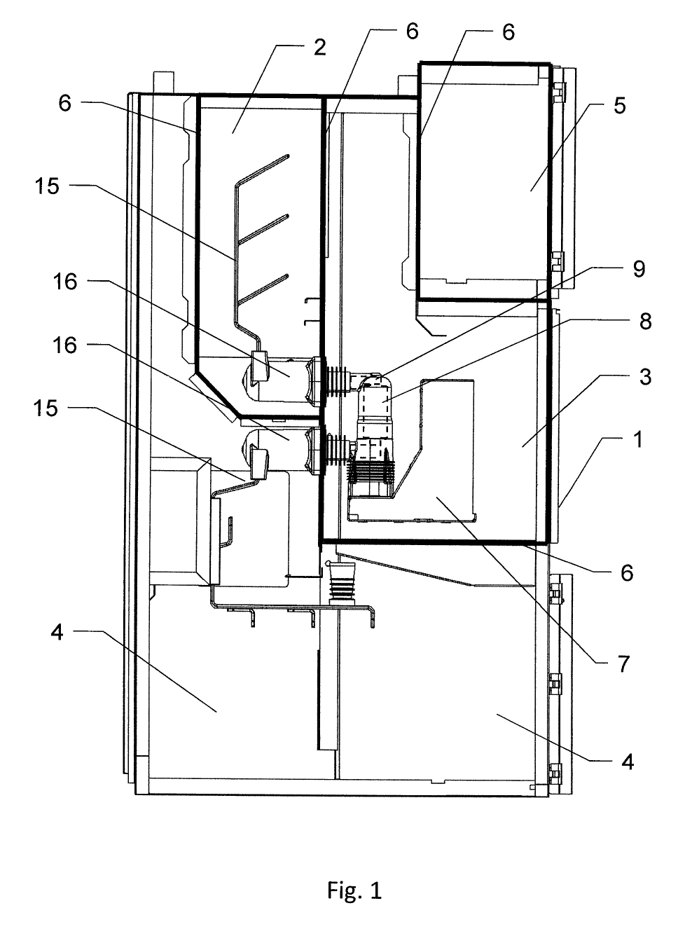

FIG. 1 shows a schematic of the distribution switchgear housing together with the circuit breaker in vertical side view with removed external wall of the distribution switchgear,

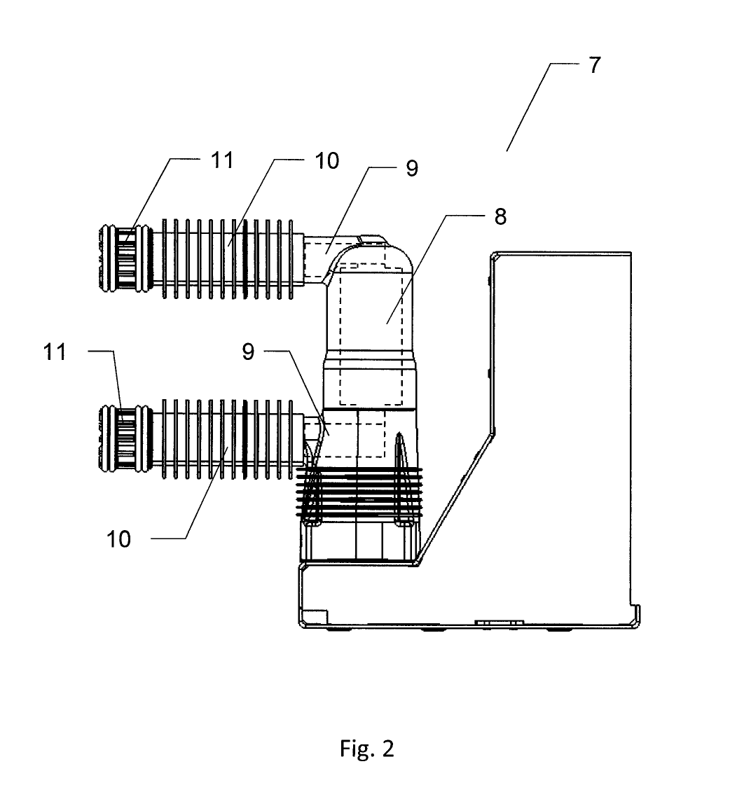

FIG. 2 shows a side view the circuit breaker,

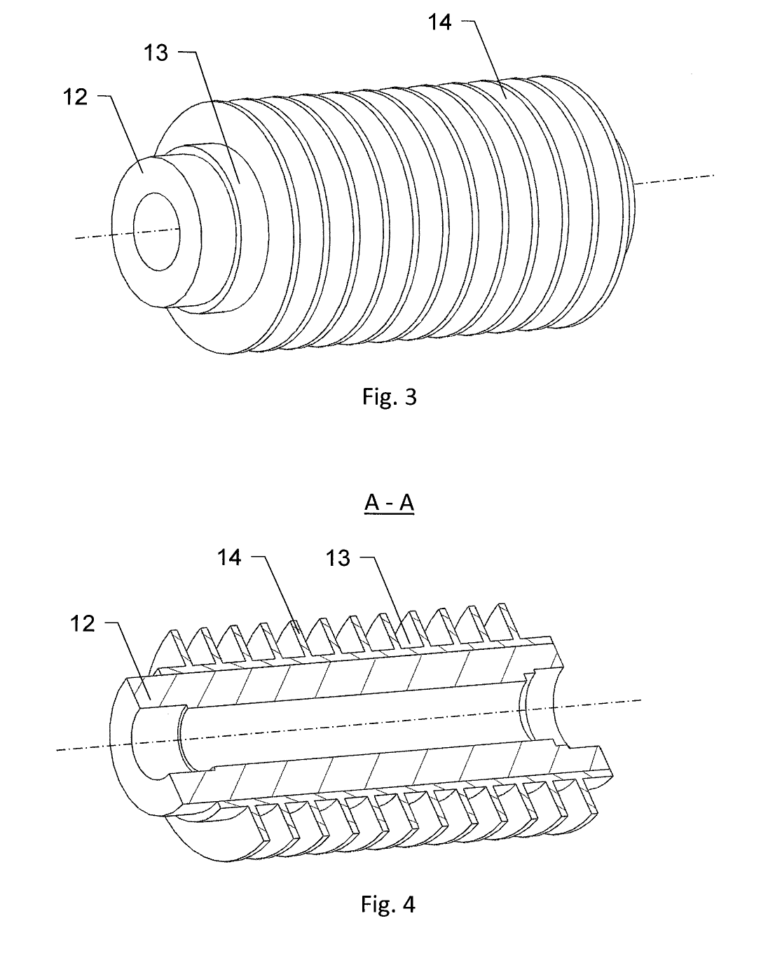

FIG. 3 shows the contact arm of the circuit breaker in axonometric projection and

FIG. 4 shows a view of the connection from FIG. 3 in longitudinal section.

The distribution switchgear whose schematic is shown in FIG. 1 has a steel housing 1 consisting of four main compartments: a bus bar compartment 2, a circuit breaker compartment 3, a cable connection compartment 4, and a low voltage compartment 5. Individual compartments are separated from one another by steel partition walls 6. In the circuit breaker compartment 3 there is located a circuit breaker 7, comprising breaking elements 8 for three phases, in the form of vacuum chambers or SF6 poles, which is shown in the drawing in dotted lines.

Each of the breaking elements 8 preferable is encapsulated in electrical insulation material, having a form of a resin casing, or is fixed to the circuit breaker in other way. The circuit breaker 7 is connected in the cable connection compartment 4 with current transformers and voltage transformers, not shown in the drawing, and with cable connections, also not shown in the drawing. The breaking element 8 is connected with the terminals 9 of the vacuum chamber or the SF6 pole of the circuit breaker 7, what is shown in the drawing in dotted lines, used to electrically connect the individual elements of the current path of the circuit breaker. To the terminals 9 are non-permanently connected contact arms 10 which are electrically connected with tulip contacts 11 to which the conduits of the current path from the cable connection compartment 4 and from the bus bar compartment 2 are connected, which is schematically shown in FIG. 1. The contact arms 10 are made in the form of a metal tube 12 with its cross-sections perpendicular to the axis of the tube (12) without discontinuities along the whole length of the tube. The lack of discontinuities in the cross-sections means that there are no “empty” spaces on the whole cross-section surfaces and that the each cross-section is a ring whose surface is completely filled. The tube 12 is permanently located in an electrically insulating casing 13 made of a thermoplastic material of increased thermal conductivity of λ≧2 W/mK and with electrically insulating properties. The metal tube 12 is permanently connected with the casing 13. The length of the casing 13 is less than the length of the metal tube 12, so that it is possible to mount a tulip contact 11 on at least one end of the tube. The casing 13 is furnished with cooling elements 14 which are situated on the outer surface of the casing 13. The shape of the cooling elements is selected to provide the best possible conduction of heat from the contact arms to the environment. Preferably, the cooling elements has the form of longitudinal ribs, transverse ribs, spiral ribs, single splines and/or their combination, but the drawing shows only the shape of the transverse ribs. The electric connection between the circuit breaker 7 and conduits 15 of the cable connection compartment and the bus bar compartment, consisting of the contact arms 10 and the tulip contacts 11, runs partly inside the insulating protective brackets 16, so called “spouts”. The brackets 16 can be made as separate elements for a single arm 10 of each phase or as one integrated element for three phases, which is not shown in the drawing.

The casing 13 of the cooling arms is made as a separately fabricated casting of a thermoplastic material characterized by high thermal conductivity λ>2 W/mK, which after hardening forms a permanent electrically insulating layer on the surface of the tube 12, and then it is pulled on the metal tube 12 and permanently attached to the outer surface of the tube 12 by means of a cement.

Preferably, the contact arms 10 are made by overmolding a metal tube 12 with a thermoplastic material characterized by a high thermal conductivity λ>2 W/mK, which after hardening forms a permanent layer having electrically insulating properties on the surface of the tube 12. The cooling elements 14 situated on the external surface of the layer form an integrated whole with the casing 13 and they are produced in one production cycle of overmolding, or first the external surface of the tube 12 is overmolded forming a smooth layer on its surface and then, using the pressure injection molding method, the cooling elements 14 are made on the outer surface of the layer. The cooling elements have the form of longitudinal ribs, transverse ribs, spiral ribs, single splines and/or their combination, but the drawing shows only the shape of transverse ribs. The arrangement of the cooling elements 14 attached to the outside of the casing 13 forms a developed surface through which heat exchange takes place between the contact arms and a cooling medium flowing around them in the distribution board switchgear, this medium being mainly a cooling medium from the circuit breaker compartment.

### A Practical Embodiment of the Invention.

An experiment was done on Vmax-type circuit breaker made according to the invention. To the breaking elements in the form of vacuum chambers there were attached contact arms in the form of copper tubes of a total length of 186 mm, with additional cooling elements made of CoolPolymer D5506 thermoplastic material which has electro-insulating properties and enhanced thermal conductivity. The outside diameter of the copper tube was 54 mm. The cooling elements on the applied contact arms according to the invention had the form of twelve transverse ribs of outside diameter of 90 mm.

For comparison, traditional contact arms used in a Vmax circuit breaker have the form of copper tubes of a total length of 186 mm and a diameter of 60 mm, with hollowed out additional openings along their length and covered with a 2 mm thick coat of electro-insulating paint.

Both solutions were compared in a test consisting in temperature measurement in several points of the Vmax circuit breaker through which rated current flowed. In this circuit breaker, on the current path of the first phase, traditional contact arms were installed, the second phase remained switched off, and on the current path of the third phase contact arms according to the invention were installed. After a time necessary for the temperatures to stabilize, it was observed that temperature indications were on average 6 K lower in measuring points in the current path of the phase with installed contact arms according to the invention, which suggests that these arms carry heat away better.

What is claimed is:

1. A power distribution switchgear circuit breaker comprising at least one breaking element in the form of vacuum chamber or SF6 pole, which is provided with electric terminals, to which there are non-permanently connected the ends of contact arms made in the form of a metal tube having an external surface covered with a layer of insulating material, characterized in that the metal tube of the contact arms has all cross-sections perpendicular to the axis of the tube without any discontinuities along the whole length of the tube and the layer of insulating material has a form of an electrically insulating casing which is furnished with cooling elements which are located on the outer surface of the casing and being an integral part with the casing and the casing is made of a thermoplastic material of thermal conductivity of λ>2 W/mK and with dielectric properties.

2. A circuit breaker according to claim 1, characterized in that the length of the insulating casing is less than the length of the metal tube.

3. A circuit breaker according to claim 2, characterized in that the cooling elements have the form of transverse, longitudinal or spiral ribs, individual splines and/or their combinations.

4. A circuit breaker according to claim 1, characterized in that breaking element is encapsulated in electrical insulation material.

5. A method of production a contact arm for the circuit breaker, characterized in that the contact arm is formed in one production cycle by overmolding a metal tube with an electrically insulating thermoplastic material having thermal conductivity of λ>2 W/mK and dielectric properties, which after hardening forms an insulating casing together with the cooling elements.

6. A method of production a contact arm for the circuit breaker, characterized in that the contact arm is formed in at least two production cycles in which, first, a metal tube is overmolded with an electrical insulating thermoplastic material having thermal conductivity of λ>2 W/mK and dielectric properties, which after hardening forms a smooth outer layer on the metal tube, and then, on the surface of this layer, the cooling elements are formed in the successive production cycles by further overmolding the tube.

7. An electric power distribution switchgear comprising a bus bar compartment, a circuit breaker compartment, a cable connection compartment, and a low voltage compartment, characterized in that a circuit breaker is located in the circuit breaker compartment and the circuit breaker is provided with at least one breaking element in the form of a vacuum chamber or a SF6 pole, which is provided with electric terminals, to which there are non-permanently connected contact arms made in the form of a metal tube having an external surface covered with a layer of insulating material, said metal tube of the contact arms has all cross-sections perpendicular to an axis of the tube without any discontinuities along a whole length of the tube and the layer of insulating material has a form of an electrically insulating casing which is furnished with cooling elements which are located on an outer surface of the casing and being an integral part of the casing and the casing is made of a thermoplastic material of thermal conductivity of >2 W/mK and with dielectric properties.
